(19) United States
(12) Patent Application Publication
(10) Pub. No.: US 2026/0075345 A1
(43) Pub. Date: Mar. 12, 2026

(54) WEARABLE DEVICE INCLUDING OPTICAL SENSOR, SYSTEM FOR ACQUIRING BIO DATA INCLUDING THE SAME, AND METHOD FOR ACQUIRING BIO DATA USING OPTICAL SENSOR

(71) Applicant: SOLUM SENSOR CO., LTD., Gyeonggi-do (KR)

(72) Inventor: SANGWOO KIM, Seoul (KR)

(21) Appl. No.: 19/321,505

(22) Filed: Sep. 8, 2025

(30) Foreign Application Priority Data
Sep. 9, 2024 (KR) 10-2024-0122732

(51) Int. Cl. H04R 1/10; G06F 1/16; G06F 3/01; H04R 1/02

(52) U.S. Cl. CPC H04R 1/1041; G06F 1/1684; G06F 3/011; H04R 1/028; H04R 1/1016; H04R 2420/07

(57) ABSTRACT

A wearable device includes an optical sensor having a light emitter configured to irradiate a user's body with light and a light-receiving unit configured to receive reflected light from the user's body to generate a photocurrent, a current removal circuit configured to generate a current for removing a portion of a direct current (DC) component of the photocurrent, and a controller configured to control an operation of the current removal circuit, and generate bio data based on a current obtained by removing a portion of the DC component equivalent to the current generated by the current removal circuit from the photocurrent.

### CROSS-REFERENCE TO RELATED APPLICATION AND CLAIM OF PRIORITY

This application claims the benefit under 35 USC § 119(a) of Korean Patent Application No. 10-2024-0122732, filed on Sep. 9, 2024, in the Korean Intellectual Property Office, the entire disclosure of which is incorporated herein by reference for all purposes.

### BACKGROUND

### 1. Technical Field

The present disclosure relates to a wearable device including an optical sensor, a system for generating bio data including the same, and a method for generating bio data using the optical sensor, and more particularly, to a wearable device which reduces the influence of an offset of an amplifier included in a current removal circuit used to remove a predetermined current from the photocurrent from the optical sensor that serves as the basis for generating bio data, a system for generating bio data including the same, and a method for generating bio data using the optical sensor.

### 2. Background Art

As modern people's interest in health grows, the healthcare industry is advancing, and accordingly, demand for wearable devices that can monitor health status is naturally increasing.

To monitor a user's health using wearable devices, highly sensitive sensors capable of capturing a variety of bio data are essential. Sensors that can be applied to wearable devices include contact electrode sensors, optical sensors, and temperature sensors.

In particular, optical sensors, which can sense health-related data such as heart rate, oxygen saturation, and sleep quality in real time by irradiating human skin with light and sensing the reflected light, are becoming increasingly important in terms of using wearable devices.

Optical sensors embedded in wearable devices should make good contact with the skin to effectively irradiate it with light. If light is emitted from the optical sensor while the optical sensor and the skin are not properly in contact, irradiation of the skin with light may not be performed, thereby lowering the sensing efficiency of bio data.

In addition, the user's heart rate data may be sensed by receiving reflected light reflected from the blood vessels by transmitting the light emitted to the user's body from the optical sensor through the skin, and analyzing the photocurrent generated by the received reflected light.

In this case, in addition to the reflected light reflected from blood vessels, which serves as the basis for heart rate data acquisition, reflected light reflected from the skin surface may also be received by the optical sensor. The photocurrent generated by the reflected light reflected from the skin surface is unnecessary for sensing heart rate data and therefore needs to be removed.

A photocurrent generated by the reflected light reflected from the user's skin surface may appear in the form of a direct current, and a current removal circuit that generates a direct current may be used to remove the photocurrent. The current removal circuit may include a current source controllable by a digital signal and may be controlled to generate a current equivalent to a current desired to be removed from the photocurrent resulting from reflected light received by the optical sensor.

However, an offset may occur in an electrical signal amplified using a reference voltage that serves as the basis for current generation by an amplifier included in a current removal circuit, and when a predetermined amount of current is removed from the photocurrent from the optical sensor using the electrical signal that reflect the offset, it may be difficult to effectively remove a desired amount of current from the photocurrent. Accordingly, the accuracy of bio data sensing may decrease.

In order to prevent the accuracy of bio data sensing from degrading due to the offset of the current removal circuit, research is needed to reduce the influence of the offset of the current removal circuit.

### SUMMARY

Various embodiments of the present disclosure are intended to provide a wearable device including an optical sensor, capable of minimizing errors in bio data due to an offset in a current removal circuit for removing unnecessary current for extracting bio data from photocurrent generated by the optical sensor, a system for acquiring bio data including the same, and a method for acquiring bio data using the optical sensor.

However, the technical problems that the various embodiments of the present disclosure seek to achieve are not limited to the technical problems described above, and other technical problems may exist.

According to an embodiment of the present disclosure, there is provided a wearable device that includes an optical sensor, the wearable device including a light emitter configured to irradiate a user's body with light, a light receiver configured to generate a photocurrent by receiving reflected light from the user's body, a current removal circuit configured to generate a current for removing a portion of a direct current (DC) component of the photocurrent, and a controller configured to control an operation of the current removal circuit and generate bio data based on a current obtained by removing a portion of the DC component equivalent to the current generated by the current removal circuit from the photocurrent, in which the current removal circuit includes a bias voltage generator configured to generate a bias voltage that serves as a basis for generating the current for removing the portion of the DC component of the photocurrent, a reference voltage generator configured to amplify the bias voltage to generate a first reference voltage reflecting a first offset at a first point in time, and to amplify the bias voltage to generate a second reference voltage reflecting a second offset at a second point in time different from the first point in time, and a voltage-to-current converter configured to convert the first reference voltage and the second reference voltage to generate a current.

In the embodiment, the first offset may be a non-inverting offset of the reference voltage generator and the second offset may be an inverting offset of the reference voltage generator.

In the embodiment, the reference voltage generator may include an amplifier configured to amplify the bias voltage to generate a reference voltage and a first switching circuit structure configured to connect the bias voltage generator and the amplifier and periodically change an input terminal of the amplifier to which the bias voltage is input.

In the embodiment, the controller may be configured to control an operation of the first switching circuit structure so that the bias voltage is input to a non-inverting input terminal of the amplifier at the first point in time and control the operation of the first switching circuit structure so that the bias voltage is input to an inverting input terminal of the amplifier at the second point in time.

In the embodiment, the current removal circuit may include a second switching circuit structure configured to periodically change an output terminal of the amplifier from which the reference voltage is output.

In the embodiment, the controller may be configured to control an operation of the second switching circuit structure so that the first reference voltage is output from a non-inverting output terminal of the amplifier at the first point in time and control the operation of the second switching circuit structure so that the second reference voltage is output from an inverting output terminal of the amplifier at the second point in time.

In the embodiment, the controller may be configured to generate data regarding a first current generated by converting the first reference voltage by the voltage-to-current converter, generate data regarding a second current generated by converting the second reference voltage by the voltage-to-current converter, generate data regarding an average current obtained by averaging the first current and the second current based on the data regarding the first current and the data regarding the second current, and generate the bio data based on data regarding a current obtained by removing a portion of the DC component equivalent to the average current from the photocurrent.

In the embodiment, the controller may be configured to generate data regarding a first reference current obtained by removing a portion of the DC component equivalent to a first current generated by converting the first reference voltage by the voltage-current converter from the photocurrent, generate data regarding a second reference current obtained by removing a portion of the DC component equivalent to a second current generated by converting the second reference voltage by the voltage-current converter from the photocurrent, generate data regarding an average reference current obtained by averaging the first reference current and the second reference current based on the data regarding the first current and the data regarding the second reference current, and generate the bio data based on the data regarding the average reference current.

In the embodiment, the controller may be configured to generate first bio data based on data regarding a first reference current obtained by removing a portion of the DC component equivalent to a first current generated by converting the first reference voltage by the voltage-current converter from the photocurrent, generate second bio data based on data regarding a second reference current obtained by removing a portion of the DC component equivalent to a second current generated by converting the second reference voltage by the voltage-current converter from the photocurrent, generate final bio data obtained by averaging the first bio data and the second bio data.

According to another embodiment of the present disclosure, there is provided a system for generating bio data, including an electronic device that includes a memory and a processor assembly, and the wearable device, in which, in the memory, an application providing a bio data acquisition service by being executed by the processor is stored.

According to still another embodiment of the present disclosure, there is provided a method for generating bio data using an optical sensor, the method including controlling an operation of the optical sensor to irradiate a user's body with light and generating data regarding a photocurrent by receiving reflected light reflected from the user's body, generating a bias voltage, acquiring data regarding a first current generated by converting a first reference voltage which is generated by amplifying the bias voltage along a first route of a reference voltage generator to reflect a first offset, acquiring data regarding a second current generated by converting a second reference voltage which is generated by amplifying the bias voltage along a second route different from the first route of the reference voltage generator to reflect a second offset different from the first offset, and generating bio data based on the data regarding the photocurrent, the data regarding the first current, and the data regarding the second current.

In the other embodiment, the generating of the bio data may include generating data regarding an average current obtained by averaging the first current and the second current based on the data regarding the first current and the data regarding the second current and generating the bio data based on data regarding a current obtained by removing a portion of the DC component equivalent to the average current from the photocurrent.

In the other embodiment, the generating of the bio data may include generating data regarding a first reference current obtained by removing a portion of the DC component equivalent to the first current from the photocurrent, generating data regarding a second reference current obtained by removing a portion of the DC component equivalent to the second current from the photocurrent, generating data regarding an average reference current obtained by averaging the first reference current and the second reference current based on the data regarding the first current and the data regarding the second reference current, and generating the bio data based on the data regarding the average reference current.

In the other embodiment, the generating of the bio data may include generating first bio data based on data regarding a first reference current obtained by removing a portion of the DC component equivalent to the first current from the photocurrent, generating second bio data based on data regarding a second reference current obtained by removing a portion of the DC component equivalent to the second current from the photocurrent, and generating final bio data obtained by averaging the first bio data and the second bio data.

### BRIEF DESCRIPTION OF THE DRAWINGS

FIG. 1 is a conceptual diagram of a system for generating bio data using an optical sensor according to an embodiment.

FIG. 2 is a block diagram illustrating functions of a server according to an embodiment.

FIG. 3 is a block diagram illustrating a structure of a wearable device according to an embodiment.

FIG. 4 is a diagram schematically illustrating a configuration of an optical sensor according to an embodiment.

FIG. 5 is a diagram illustrating a process in which a portion of a photocurrent generated from a light receiver is removed by a current removal circuit according to an embodiment.

FIG. 6 is a block diagram illustrating the configuration of an embodiment of a digital-to-analog converter (DAC) included in the circuit configuration of FIG. 5.

FIG. 7 is a diagram schematically illustrating a structure of a DAC according to an embodiment.

FIG. 8 is a circuit diagram schematically illustrating a structure of a reference voltage generator included in a DAC according to an embodiment.

FIG. 9 is a circuit diagram schematically illustrating a structure of the reference voltage generator of FIG. 8 at a first point in time.

FIG. 10 is a circuit diagram schematically illustrating a structure of the reference voltage generator of FIG. 8 at a second point in time.

FIG. 11 is a circuit diagram schematically illustrating a structure of a bias voltage generator and a reference voltage generator included in a DAC according to another embodiment.

FIG. 12 is an internal block diagram of an electronic device according to an embodiment.

FIG. 13 is a flowchart of a method for acquiring bio data using an optical sensor according to an embodiment.

FIG. 14 is a flowchart of a step of generating bio data according to an embodiment of the method of FIG. 12.

FIG. 15 is a flowchart of a step of generating bio data according to another embodiment of the method of FIG. 12.

FIG. 16 is a flowchart of a step of generating bio data according to another embodiment of the method of FIG. 12.

### DETAILED DESCRIPTION

The present disclosure may undergo various modifications and has various embodiments, and specific embodiments are illustrated in the drawings and described in detail in the detailed description. The effects and features of the present disclosure, as well as the methods for achieving them, will become clearer with reference to the embodiments described in detail below, along with the drawings. However, the present disclosure is not limited to the embodiments disclosed below and may be implemented in various forms. In the embodiments below, terms “first, “second,” etc. are not used in a limiting sense, but are used for the purpose of distinguishing one component from another. In addition, singular expressions include plural expressions unless the context clearly indicates otherwise. In addition, terms such as “include” or “have” mean that a feature or component described in the specification exists, and do not preclude the possibility that one or more other features or components may be added. In addition, in the drawing, components may be exaggerated or reduced in size for convenience of description. For example, the size and thickness of each component shown in the drawings are arbitrarily indicated for convenience of description, and thus the present disclosure is not necessarily limited to those shown in the drawings.

Hereinafter, embodiments of the present disclosure will be described in detail with reference to the accompanying drawings. When describing with reference to the drawings, identical or corresponding components are given the same reference numerals, and redundant descriptions thereof will be omitted.

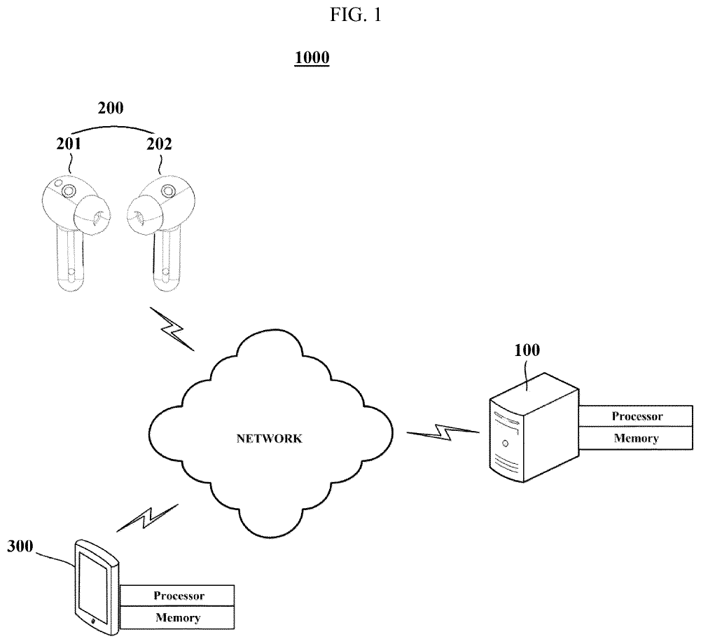

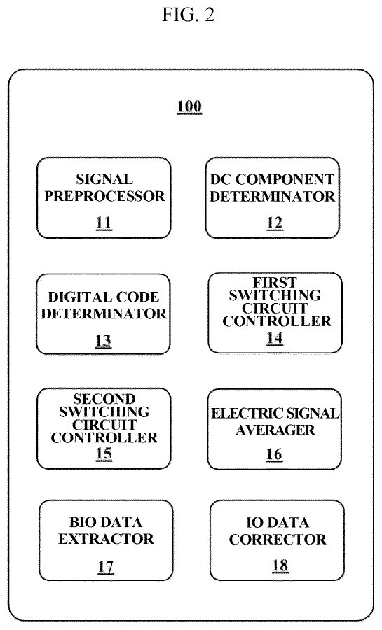

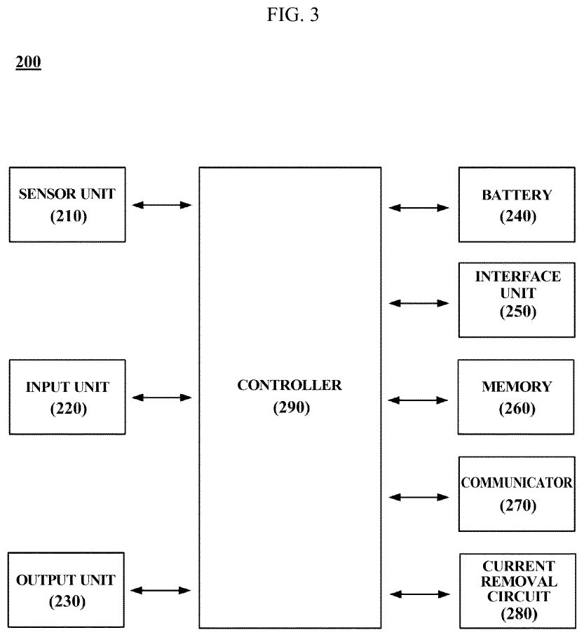

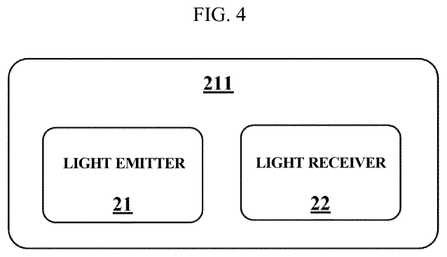

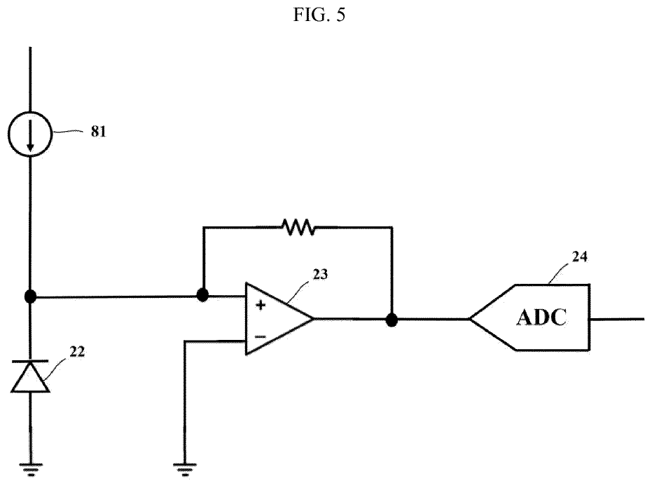

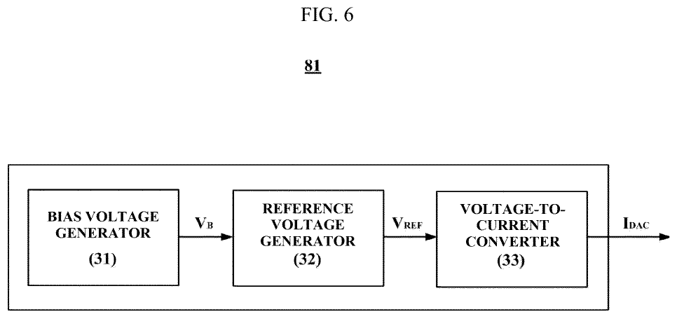

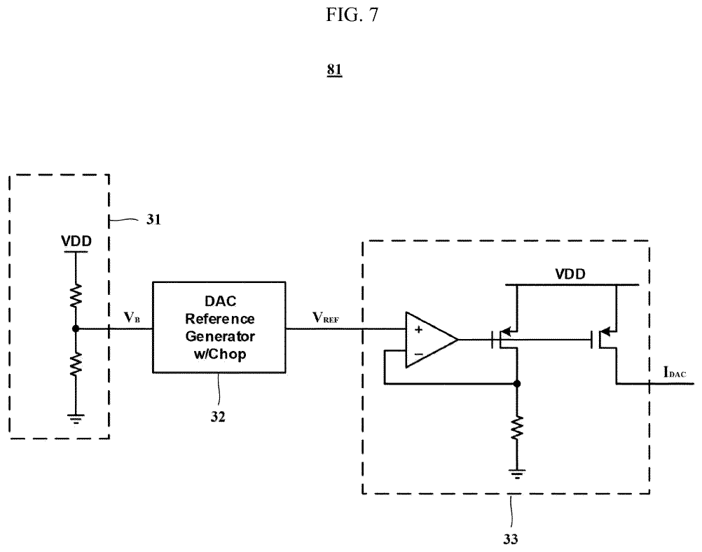

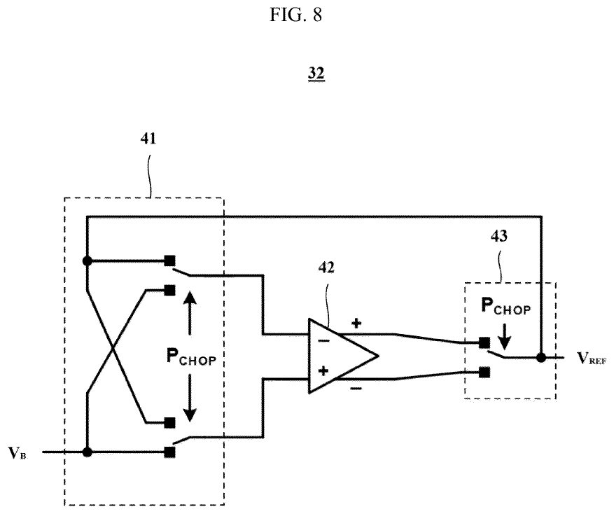

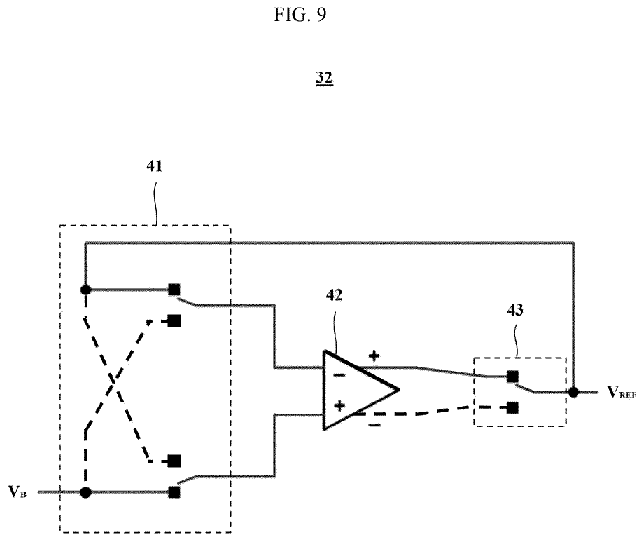

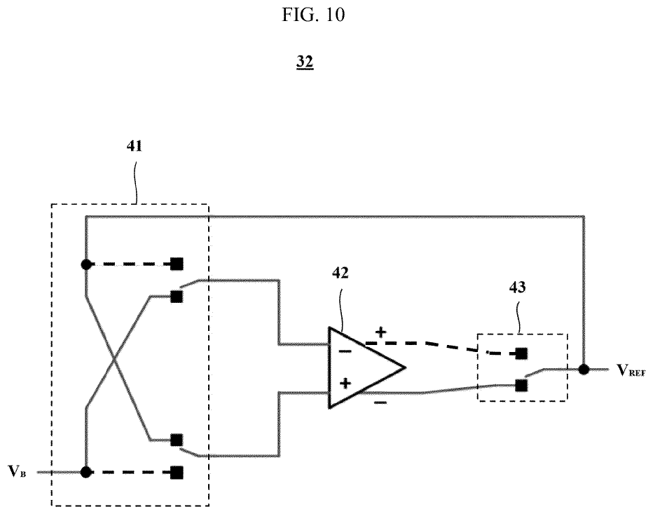

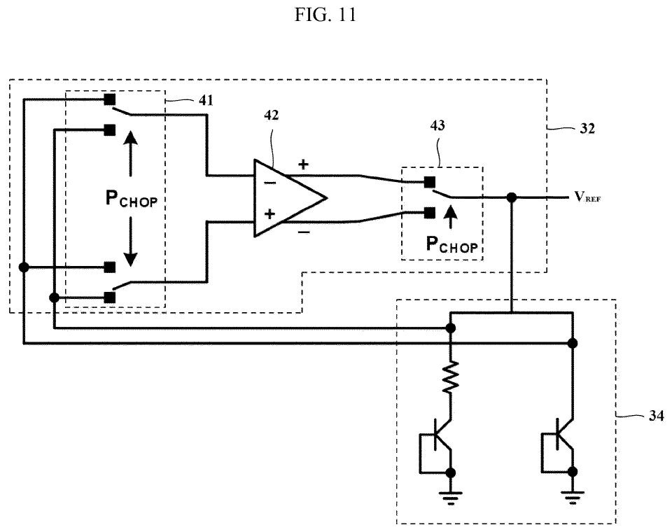

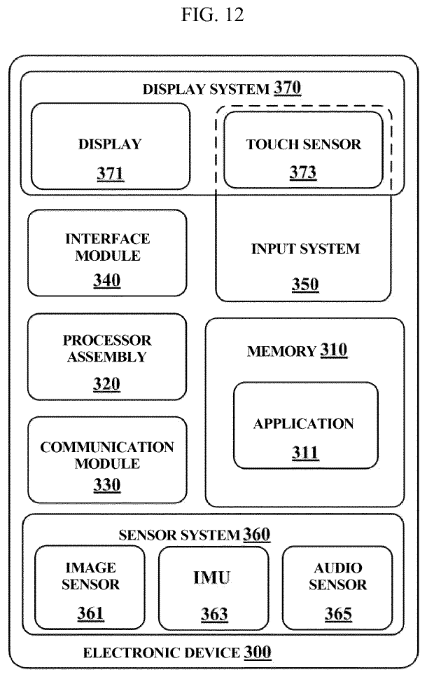

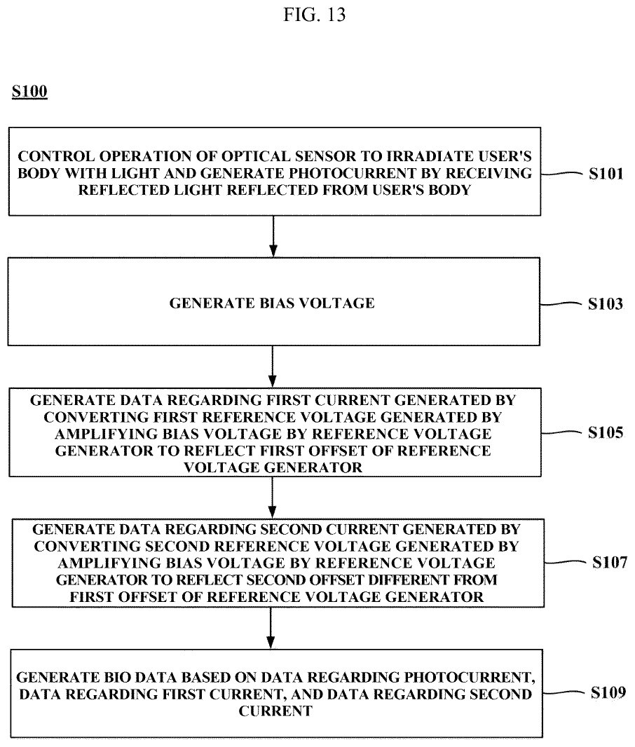

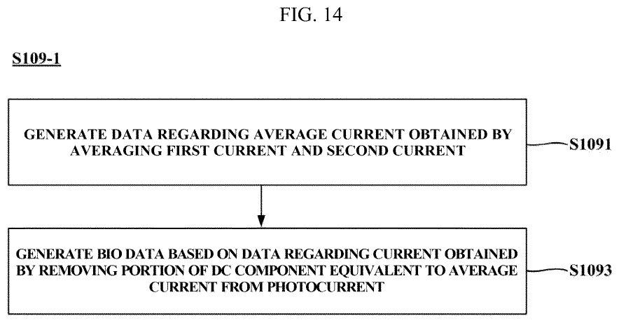

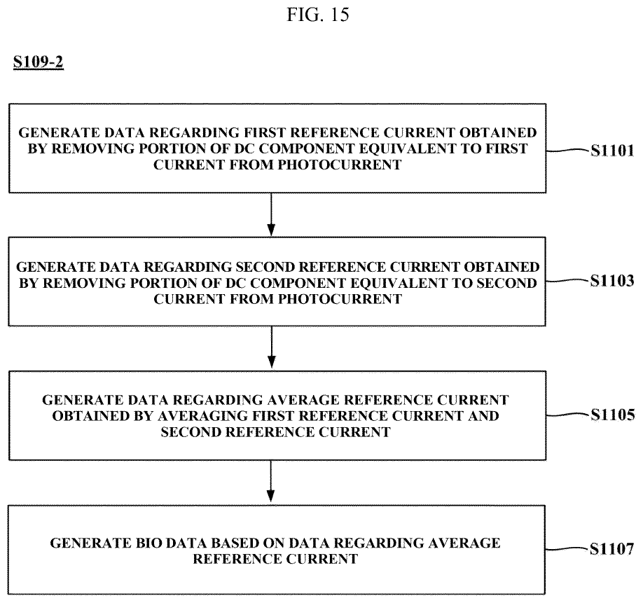

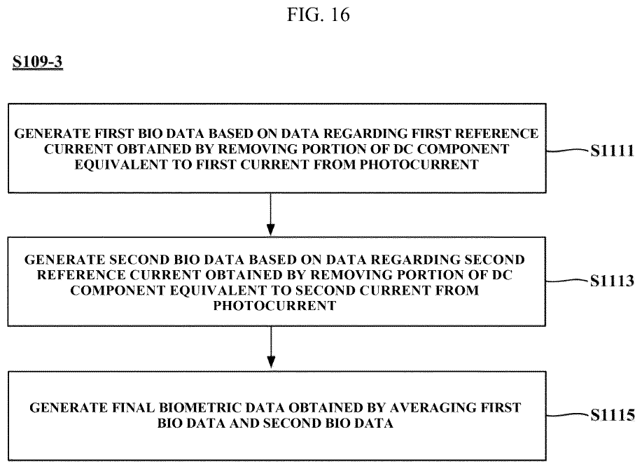

FIG. 1 is a conceptual diagram of a system for acquiring bio data 1000 using an optical sensor according to an embodiment. FIG. 2 is a block diagram illustrating functions of a server 100 according to an embodiment. FIG. 3 is a block diagram illustrating a structure of a wearable device 200 according to an embodiment. FIG. 4 is a diagram schematically illustrating a configuration of an optical sensor 211 according to an embodiment. FIG. 5 is a diagram illustrating a process in which a portion of the photocurrent generated from a light receiver 22 is removed by a current removal circuit 280 according to an embodiment. FIG. 6 is a block diagram illustrating the configuration of an embodiment of a digital-to-analog converter (DAC) 81 included in the circuit configuration of FIG. 5. FIG. 7 is a diagram schematically illustrating a circuit structure of the DAC 81 according to an embodiment. FIG. 8 is a circuit diagram schematically illustrating a structure of a reference voltage generator 32 included in the DAC 81 according to an embodiment. FIG. 9 is a circuit diagram schematically illustrating a structure of the reference voltage generator 32 of FIG. 8 at a first point in time. FIG. 10 is a circuit diagram schematically illustrating a structure of the reference voltage generator 32 of FIG. 8 at a second point in time. FIG. 11 is a circuit diagram schematically illustrating a structure of a bias voltage generator 34 and the reference voltage generator 32 included in the DAC 81 according to another embodiment. FIG. 12 is an internal block diagram of an electronic device 300 according to an embodiment. FIG. 13 is a flowchart of a method for acquiring bio data using an optical sensor (S100) according to an embodiment. FIG. 14 is a flowchart of a step of generating bio data (S109-1) according to an embodiment of the method (S100) of FIG. 12. FIG. 15 is a flowchart of a step of generating bio data (S109-2) according to another embodiment of the method (S100) of FIG. 12. FIG. 16 is a flowchart of a step of generating bio data (S109-3) according to still another embodiment of the method (S100) of FIG. 12.

Referring to FIG. 1, the system for generating bio data 1000 using an optical sensor according to an embodiment may include the server 100, the wearable device 200, and the electronic device 300. The server 100, the wearable device 200, and the electronic device 300 may transmit and receive data to and from each other via a network.

The system 1000 according to an embodiment may measure various types of bio data, such as the user's heart rate data and body temperature data measured by the sensor unit 210 included in the wearable device 200 and provide a service that guides a user to a customized exercise program based on the measured bio data. Here, heart rate data may be referred to as photoplethysmogram (PPG) data.

In addition, the system for generating bio data 1000 may minimize errors in bio data by minimizing the influence of the offset of an amplifier 42 included in a current removal circuit 280 used to remove noise current from the photocurrent from an optical sensor 211 included in a wearable device 200 by performing a predetermined operation.

For example, the wearable device 200 may include the current removal circuit 280 for removing a predetermined current from the photocurrent generated by the optical sensor 211 irradiating the user's body with light and receiving reflected light reflected from the user's body.

The current removal circuit 280 may include the amplifier 42 necessary to generate a predetermined current, and depending on the structure of the amplifier 42, an offset may occur in an electric signal amplified by the amplifier 42. Accordingly, the current actually generated by the current removal circuit 280 according to a control signal may have a difference from a reference current determined to be generated by the current removal circuit 280 according to the control signal.

The system 1000 may minimize the influence of offset that may occur on an electrical signal amplified by the amplifier 42 by controlling the operation of predetermined switching circuits 41 and 43 connected to the amplifier 42. In this way, the system 1000 may minimize errors in bio data by minimizing the influence of the offset of the amplifier 42 included in the current removal circuit 280.

The wearable device 200 may be an electronic device that may be worn on the user's body, such as clothing or accessories. For example, the wearable device 200 may include a smartwatch, a smart band, smart glasses, etc. Furthermore, as illustrated in FIG. 1, the wearable device 200 may include a hearable device, such as a completely wireless earphone including a left ear unit 201 and a right ear unit 202.

Here, the term “hearable device” is a compound word of the words “hear” and “wearable,” and may mean a wearable device focused on hearing that provides various convenient functions, such as voice recognition, integration with voice recognition artificial intelligence, music playback, and phone calls.

The system 1000 may acquire sensing data based on a predetermined biosensor included in the wearable device 200, and provide the user with biofeedback content generated based on user's bio-information, exercise amount information, posture information, etc. calculated based on the acquired sensing data.

The network according to the embodiment means a connection structure that enables information exchange between nodes, such as the server 100, the wearable device 200, and/or the electronic device 300, and examples of such a network include, but are not limited to, a 3rd generation partnership project (3GPP) network, a long term evolution (LTE) network, a world interoperability for microwave access (WiMAX) network, the Internet, a local area network (LAN), a wireless local area network (Wireless LAN), a wide area network (WAN), a personal area network (PAN), a Bluetooth network, a satellite broadcasting network, an analog broadcasting network, and a digital multimedia broadcasting (DMB) network.

Hereinafter, the server 100, wearable device 200, and electronic device 300 implementing the system 1000 will be described in detail with reference to the accompanying drawings.

### Server 100

The server 100 according to an embodiment may perform a series of processes for providing an environment for acquiring bio data and providing biofeedback content.

In detail, in the embodiment, the server 100 may provide a bio data acquisition environment and biofeedback content to a user by exchanging data necessary to drive a bio data acquisition process and a biofeedback content provision process with an external device, such as the wearable device 200 and the electronic device 300.

More specifically, in an embodiment, the server 100 may provide an environment in which an application 311 can operate on the electronic device 300 (e.g., a mobile type computing device and/or a desktop type computing device, in an embodiment).

To this end, the server 100 may include application programs, data, and/or instructions for the application 311 to operate on the electronic device 300, and may transmit and receive various data based on these to and from the external device.

The server 100 may store and manage at least one or more pieces of sensing data, user body information, user condition information, user exercise information, test results, heart rate information, biofeedback content, user exercise ability, and/or exercise programs.

However, in the embodiment of the present disclosure, the functional operations that the server 100 can perform are not limited to those described above, and other functional operations may be performed.

Referring again to FIG. 1, in an embodiment, the server 100 described above may be implemented as a predetermined computing device including at least one or processors for data processing and at least one or more memories for storing various application programs, data, and/or instructions for acquiring bio data.

In addition, the memory may include a program area and a data area. Here, the program area according to the embodiment may be linked between an operating system (OS) that boots the server and functional elements, and the data area may store data generated according to the use of the server 100.

In the embodiment, the memory may be a variety of storage devices, such as ROM, RAM, EPROM, flash drive, hard drive, etc., or may be web storage that performs a storage function of the memory on the Internet.

Meanwhile, the at least one or more processors may perform various operations for acquiring bio data. The at least one or processors may be a system-on-chip (SOC) suitable for a server, including a central processing unit (CPU) and/or a graphics processing unit (GPU), and may execute an operating system (OS) and/or application programs stored in the memory.

In addition, at least one or more processors may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

In addition, referring to FIG. 2, at least one processor of the server 100 may perform the functions of a signal preprocessor 11, a DC component determinator 12, a digital code determinator 13, a first switching circuit controller 14, a second switching circuit controller 15, an electric signal averager 16, a bio data extractor 17, and a bio data corrector 18.

The signal preprocessor 11 may perform preprocessing on the photocurrent signal caused by reflected light reflected from the user's body. For example, the signal preprocessor 11 may perform at least one preprocessing among smoothing processing, high-frequency noise filtering, and baseline drift correction.

Smoothing processing extracts only a pattern of a signal according to the photocurrent caused by the reflected light reflected from the user's body, which may mean removing residual peaks contained in the reflected light.

The signal preprocessor 11 may perform smoothing processing on the photocurrent signal caused by reflected light using a known smoothing processing technique. For example, the signal preprocessor 11 may utilize a plurality of low-pass filters to perform smoothing processing on the photocurrent signal caused by the reflected light.

High-frequency noise filtering may mean the removal of high-frequency noise, which corresponds to noise caused by environmental factors, electric field interference, motion artifacts, etc., in addition to signals representing biological changes.

The signal preprocessor 11 may perform high-frequency noise filtering on a photocurrent signal generated by reflected light using a known high-frequency noise filtering technique. For example, the signal preprocessor 11 may perform high-frequency noise filtering on the photocurrent signal generated by reflected light using a low-pass filter, a Kalman filter, etc.

Baseline drift correction may mean correcting a baseline drift, in which a line, which is a reference of data that should be constant due to environmental interference, motion artifacts, etc., fluctuates. Baseline drift may interfere with extracting desired information from received data.

The signal preprocessor 11 may utilize filtering techniques, baseline correction algorithms, and appropriate calibration operations, etc. to perform baseline drift correction. This minimizes baseline fluctuations and allows meaningful information to be extracted from original bio data.

The DC component determinator 12 may determine an amount of removal for the photocurrent generated by irradiating the user's body with light from the optical sensor 211 of the wearable device 200 and receiving the reflected light reflected from the user's body by the optical sensor 211. Data regarding the photocurrent from the optical sensor 211 may be transmitted to the DC component determinator 12 via a network, and the DC component determinator 12 may analyze data on the photocurrent and determine the removal amount for the photocurrent that allows optimal bio data to be generated from the photocurrent.

For example, a portion of the light with which the user's body is irradiated from the optical sensor 211 may penetrate the user's skin and be reflected from blood vessels, while the other portion may be reflected from the user's skin. The optical sensor 211 may generate a photocurrent by receiving both the reflected light reflected from blood vessels and reflected light reflected from the user's skin. This photocurrent may include both a direct current (DC) component and an alternating current (AC) component.

Here, the DC component of the photocurrent from the optical sensor 211 may be due to reflected light reflected from the user's skin, while the AC component may be due to reflected light reflected from blood vessels.

For example, heart rate data may be acquired through an analysis of the AC component contained in the photocurrent from the optical sensor 211, and oxygen saturation data may be acquired through an analysis of a ratio of the AC component to the DC component of the photocurrent from the optical sensor 211. Accordingly, the DC component of the photocurrent from the optical sensor 211 may correspond to noise current that is of low importance in acquiring bio data such as heart rate data and oxygen saturation data.

In addition, if the DC component of the photocurrent is not sufficiently removed, saturation may occur in the process of amplifying the photocurrent, and thus it may be difficult to acquire bio data from the photocurrent.

Therefore, in order to generate more accurate bio data, it is necessary to remove at least a portion of the DC component contained in the photocurrent from the optical sensor 211.

The DC component determinator 12 may determine the amount of DC component to be removed from the photocurrent from the optical sensor 211 of the wearable device 200. In this case, the DC component determinator 12 may dynamically determine the amount of DC component to be removed from the photocurrent from the optical sensor 211.

The DC component contained in the photocurrent from the optical sensor 211 may have different values depending on various variables such as humidity and contact strength, and accordingly, the amount of DC component that should be removed from the photocurrent for bio data acquisition may also vary depending on the data measurement point in time.

For example, if the DC component of the photocurrent from the optical sensor 211 is 900 mA, the DC component to be removed from the photocurrent may be determined to be 500 mA. Furthermore, if the DC component of the photocurrent from the optical sensor 211 increases to 950 mA, the DC component to be removed may also be determined to be the increased value of 600 mA.

When the amount of DC component to be removed from the photocurrent from the optical sensor 211 is determined, the digital code determinator 13 may determine a digital code for generating a current corresponding to the determined amount of DC component.

For example, as described below, a digital-to-analog converter (DAC) 81 included in the current removal circuit 280 of the wearable device 200 may be controlled to generate a current for removing a portion of the DC component from the photocurrent.

In this case, the DAC 81 may be controlled based on a digital code to generate a current for removing a portion of the DC component of the photocurrent. The digital code determinator 13 may determine a digital code for controlling driving of the DAC 81.

For example, if the DC component determinator 12 determines the DC component to be removed from the photocurrent as 500 mA, the digital code determinator 13 may determine a digital code that can control the DAC 81 to generate a current of 500 mA.

The first switching circuit controller 14 may control the operation of the first switching circuit structure 41 configured to change an input terminal of the amplifier 42 to which a bias voltage V_{B} from the bias voltage generator 31 is input, as described below.

For example, the first switching circuit structure 41 may be configured to be controlled so that the bias voltage V_{B} is input to a non-inverting input terminal of the amplifier 42 and an inverting input terminal of the amplifier 42 is connected to an output terminal of the amplifier 42 at a first point in time.

In addition, the first switching circuit structure 41 may be configured to be controlled so that the bias voltage V_{B} is input to the inverting input terminal of amplifier 42 and the non-inverting input terminal of amplifier 42 is connected to the output terminal of amplifier 42 at a second point in time different from the first point in time.

The first switching circuit controller 14 may change a connection structure of the first switching circuit structure 41 to the amplifier 42 so that a route through which the bias voltage V_{B} is amplified by the first switching circuit structure 41 may be changed by controlling the operation of at least one switch included in the first switching circuit structure 41.

The second switching circuit controller 15 may control the operation of the second switching circuit structure 43 configured to change the output terminal of the amplifier 42 for a voltage output from the amplifier 42, as described below.

For example, the second switching circuit structure 43 may be configured to be controlled so that the voltage output from the amplifier 42 is output from a non-inverting output terminal of the amplifier 42, at the first point in time.

In addition, the second switching circuit structure 43 may be configured to be controlled so that the voltage output from the amplifier 42 is output from an inverting output terminal of the amplifier 42 at a second point in time different from the first point in time.

The second switching circuit controller 15 may change the connection structure of the first switching circuit structure 41 to the amplifier 42 so that a route through which the output voltage from the amplifier 42 is output by the second switching circuit structure 43 may be changed by controlling the operation of at least one switch included in the second switching circuit structure 43.

The electric signal averager 16 may generate data regarding a first current generated by converting a first reference voltage output from the amplifier 42 by the voltage-current converter 33 in a state where the bias voltage V_{B} is input to the non-inverting input terminal of the amplifier 42 by the first switching circuit structure 41 and the inverting input terminal of the amplifier 42 is connected to the output terminal of the amplifier 42, at the first point in time. Here, data regarding the first current may include data on a change in the magnitude of the first current over time.

In addition, the electric signal averager 16 may generate data regarding a second current generated by converting a second reference voltage output from the amplifier 42 by the voltage-current converter 33 in a state where the bias voltage V_{B} is input to the inverting input terminal of the amplifier 42 by the first switching circuit structure 41 and the non-inverting input terminal of the amplifier 42 is connected to the output terminal of the amplifier 42, at the second point in time different from the first point in time. Here, data regarding the second current may include data on a change in the magnitude of the second current over time.

In this case, the first current may reflect a non-inverting offset of the amplifier 42, and the second current may reflect an inverting offset of the amplifier 42.

The electrical signal averager 16 may generate average current data by averaging data regarding the first current and data regarding the second current.

As the data regarding the first current and the data regarding the second current are averaged by the electric signal averager 16, the influence of the offset of the amplifier 42 on each of the data regarding the first current and the data regarding the second current may be minimized.

For example, the non-inverting offset of the amplifier 42 for the first current and the inverting offset of the amplifier 42 for the second current may be equal in magnitude and opposite in direction. Accordingly, during the process of averaging data for the first current and data for the second current, the influences of the non-inverting offset and inverting offset of the amplifier 42 may be cancel each other out, and the influence of the offset of the amplifier 42 on the data for the first current and the data for the second current data may be minimized.

In addition, the electric signal averager 16 may generate data regarding a first reference current obtained by removing a portion of the DC component equivalent to the first current generated by converting the first reference voltage output from the amplifier 42 by the voltage-current converter 33 at the first point in time from the photocurrent from the light receiver 22.

Here, the first current may reflect the non-inverting offset of the amplifier 42, and the first reference current may be a current obtained by removing a portion of the DC component equivalent to the first current in which the non-inverting offset of the amplifier 42 is reflected from the photocurrent from the light receiver 22.

Furthermore, the electric signal averager 16 may generate data regarding a second reference current obtained by removing a portion of the DC component equivalent to the second current generated by converting the second reference voltage output from the amplifier 42 by the voltage-current converter 33 at the second point in time from the photocurrent from the light receiver 22.

Here, the second current may reflect the inverting offset of the amplifier 42, and the second reference current may be a current obtained by removing a portion of the DC component equivalent to the second current in which the inverting offset of the amplifier 42 is reflected from the photocurrent from the light receiver 22.

The electric signal averager 16 may generate average reference current data by averaging the data regarding the first reference current and the data regarding the second reference current.

As the data regarding the first reference current and the data regarding the second reference current are averaged by the electric signal averaging unit (16), the influence of the offset of the amplifier 42 on the first current and the influence of the offset of the amplifier 42 on the second current may be cancel each other out. Accordingly, the average reference current data may be data in which the influence of the offset of the amplifier 42 is minimized.

The bio data extractor 17 may generate bio data based on the current obtained by removing the DC component equivalent to a current generated from the DAC 81 according to the digital code determined by the digital code determinator 13 from the photocurrent from the light receiver 22.

For example, the bio data extractor 17 may generate bio data based on the current obtained by removing a portion of the DC component from the photocurrent by utilizing a bio data extraction algorithm. In this case, for example, the bio data extractor 17 may generate PPG data based on the current obtained by removing the portion of the DC component from the photocurrent by utilizing a PPG data extraction algorithm.

For example, the bio data extractor 17 may generate first bio data based on the first reference current obtained by removing a portion of the DC component equivalent to the first current generated by converting the first reference voltage output from the amplifier 42 by the voltage-current converter 33 at the first point in time from the photocurrent from the light receiver 22. In this case, the first bio data may be data that reflects the influence of the non-inverting offset of the amplifier 42.

In addition, for example, the bio data extractor 17 may generate second bio data based on the second reference current obtained by removing a portion of the DC component equivalent to the first current generated by converting the second reference voltage output from the amplifier 42 by the voltage-current converter 33 at the second point in time from the photocurrent from the light receiver 22. In this case, the second bio data may be data that reflects the influence of the inverting offset of the amplifier 42.

In this way, the bio data based on the current obtained by removing the DC component equivalent to the current generated from the DAC 81 from the photocurrent from the optical sensor 211 is data that reflects the offset of the amplifier 42 of the reference voltage generator 32 included in the DAC 81, and therefore, correction may be required for this.

Correction of bio data based on the current obtained by removing the DC component equivalent to the current generated from the DAC 81 from the photocurrent from the optical sensor 211 may be corrected by the bio data corrector 18 in the manner described below.

In addition, the bio data extractor 17 may generate bio data based on a current obtained by removing a current equivalent to an average current corresponding to the average current data generated by the electric signal averager 16 from the photocurrent from the light receiver 22.

Since the influence of the offset of the amplifier 42 is minimized during the process of generating average current data by averaging the data regarding the first current and the data regarding the second current by the electric signal averager 16, bio data based on a current obtained by removing a current equivalent to the average current data from the photocurrent from the optical sensor 211 may be data in which the influence of the offset of the amplifier 42 is minimized.

Furthermore, the bio data extractor 17 may generate bio data based on average reference current data generated by the electric signal averager 16.

Since the influence of the offset of the amplifier 42 is minimized during the process of generating the average reference current data by averaging the data regarding the first current and the data regarding the second current by the electric signal averager 16, bio data based on the average reference current data may be data in which the influence of the offset of the amplifier 42 is minimized.

The bio data corrector 18 may perform correction on the first bio data that reflects the influence of the non-inverting offset of the amplifier 42 and second bio data that reflects the influence of the inverting offset of the amplifier 42 that are generated by the bio data extractor 17.

For example, the bio data corrector 18 may generate final bio data by averaging the first bio data and the second bio data.

During the process of averaging the first bio data and the second bio data by the bio data corrector 18, the non-inverting offset of the amplifier 42 for the first bio data and the inverting offset of the amplifier 42 for the second bio data may be cancelled each other out. Accordingly, the final bio data may be data in which the influence of the offset of the amplifier 42 is minimized.

In the above description, although it has been described that the server 100 according to an embodiment of the present disclosure performs the functional operations described above, various embodiments may be possible, such as, depending on the embodiment, at least a portion of the functional operations performed by the server 100 may be performed by the external device (e.g., the wearable device 200, the electronic device 300, etc.), and at least a portion of the functional operations performed by the external device may be further performed by the server 100.

### Wearable Device 200

The wearable device 200 according to an embodiment may be an electronic device that may be linked with an application 311 that provides biofeedback content installed on the electronic device 300 and may be worn on a user's body.

The wearable device 200 may take various forms, such as a smartwatch, a smart band, and smart glasses. Furthermore, the wearable device 200 may include a hearable device, such as a completely wireless earphone including a left ear unit 201 and a right ear unit 202, as illustrated in FIG. 1.

Hereinafter, the wearable device 200 will be described as being implemented as a hearable device, but the wearable device 200 may be implemented as any device that may be linked with the electronic device 300 and worn on the user's body.

Referring to FIG. 3, from a functional point of view, the wearable device 200 may include a sensor unit 210, an input unit 220, an output unit 230, a battery 240, an interface unit 250, a memory 260, a communicator 270, a current removal circuit 280, and a controller 290. These components may be configured to be included within the housing of the wearable device 200, for example.

The sensor unit 210 may include various types of biosensors, such as an optical sensor that senses photoplethysmogram (PPG) data and a body temperature sensor. In addition, the sensor unit 210 may further include various sensors such as a position sensor (IMU), an audio sensor, a distance sensor, a proximity sensor, and a contact sensor.

In an embodiment, the sensor unit 210 may include an optical sensor 211 for collecting PPG data from a user wearing the wearable device 200.

The optical sensor 211 may be a sensor that measures the amount of blood flowing in peripheral blood vessels by irradiating the user's skin with green light or red light using a green light source or red light source, receiving light transmitted through or reflected from the skin using a light receiving element, and measuring the user's pulse, etc. based on the received light signal.

Referring to FIG. 4, the optical sensor 211 may include a light emitter 21 that irradiates the user's body with light and a light receiver 22 that receives reflected light from the user's body.

The light emitter 21 may irradiate the user's body with light. The light emitter 21 may include at least one light emitting element. For example, at least one light emitting element included in the light emitter 21 may include an LED.

The light receiver 22 may include at least one light receiving element that receives reflected light reflected from the user's body. At least one light receiving element included in the light receiver 22 may include a photodiode. At least one light receiving element of the light receiver 22 may generate a photocurrent based on the reflected light reflected from the user's body.

The position sensor (IMU) may detect at least one or more of the movement, acceleration, and/or inclination of the wearable device 200. For example, the position sensor (IMU) may be made up of a combination of various position sensors, such as an accelerometer, a gyroscope, and a magnetometer. Such a position sensor (IMU) may also be referred to as a motion sensor.

In detail, in the embodiment, the position sensor may measure the user's movement amount based on the acceleration sensor. Furthermore, in the embodiment, the position sensor may measure the user's posture by obtaining a difference in inclination between the user's left and right sides.

In addition, the position sensor (IMU) may recognize spatial information about the physical space surrounding the wearable device 200 by linking with the GPS of the communicator 270.

The audio sensor may recognize sounds surrounding the wearable device 200.

In detail, the audio sensor may include a microphone capable of detecting voice input from a user using the wearable device 200.

The distance sensor may measure the distance between the wearable device 200 and the electronic device 300.

The proximity sensor may detect the electronic device 300 and/or the user's body that are in proximity to the wearable device 200.

The contact sensor may detect an object and/or the user's body that are in contact with the wearable device 200.

That is, the wearable device 200 according to the embodiment may acquire sensing data including at least one or more of heart rate data, oxygen saturation data, location data, distance data, and/or posture data based on the sensor unit 210 including the plurality of sensors described above.

The input unit 220 may detect a user's input (e.g., a gesture, a voice command, a touch input, an operation of a button, or another type of input).

In detail, the input unit 220 may include a predetermined pressure sensor (e.g., a button) and/or touch sensor for detecting a user's input.

In addition, the input unit 220 may be configured in the form of a touch screen unit and/or a touch screen panel. Specifically, the input unit may be configured as one of a resistive film method, a capacitive method, an optical method, or an ultrasonic method, but the use of the capacitive method is preferred.

In addition, the input unit 220 may acquire a predetermined control signal for controlling the wearable device 200 and/or the electronic device 300 based on the touch sensor.

In detail, the input unit 220 may transmit a signal including the number of detected touches to the controller 290. Accordingly, the controller 180 may execute a predetermined process pre-matched to the signal. For example, if the user inputs one short touch, a process for pausing playback while listening to music may be executed. Furthermore, if the user inputs two short touches, a process for playing the next song while listening to music may be executed.

The output unit 230 may include a predetermined audio output device (hereinafter, a speaker).

In detail, the output unit 230 may include an internal speaker that transmits sound to a user wearing the wearable device 200 and an external speaker that transmits sound to the outside of the earphones.

The internal speaker may provide sound including biofeedback content and/or music. Furthermore, the external speaker may provide sound including a predetermined signal tone in the event of loss.

In addition, the output unit 230 may include a predetermined lighting and/or a vibration module. For example, the lighting and/or the vibration module may operate upon the occurrence of a specific event, such as pairing and/or loss.

The battery 240 is implemented in the form of a rechargeable secondary battery and may include a wired charging module and/or a wireless charging module.

In detail, the battery 240 may apply a predetermined power from a power supply of a predetermined digital device when connected to the digital device in a wired manner (e.g., USB cable, etc.) based on the wired charging module.

In addition, the battery 240 may apply a predetermined power from the power supply of a predetermined digital device when wirelessly connected to the digital device based on the wireless charging module.

The interface unit 250 may communicatively connect the wearable device 200 to one or more other devices. In detail, the interface unit 250 may include wired and/or wireless communication devices compatible with one or more different communication protocols.

Through the interface unit 250, the wearable device 200 may be connected to various input/output devices (e.g., electronic devices 300).

The memory 260 may store one or more of various application programs, data, and instructions for generating and providing an environment for providing bio data and biofeedback content.

In addition, the memory 260 may include a program area and a data area.

Here, the program area according to the embodiment may be linked between the operating system (OS) that boots the wearable device 200 and the functional elements, and the data area may store data generated during the use of the wearable device 200.

In addition, the memory 260 may include at least one or more non-transitory computer-readable storage media and a temporary computer-readable storage medium.

In addition, the memory 260 may store predetermined sensing data acquired from the sensor unit 210.

The communicator 270 may include one or more devices for communicating with external devices. This communicator 270 may communicate via a wireless network.

In detail, the communicator 270 may communicate with the electronic device 300 that stores content sources for implementing the environment for providing bio data and biofeedback content, and may communicate with various user input components, such as a controller that receives user input.

In the embodiment, the communicator 270 may transmit and receive various data (e.g., bio signals and/or sensing data) related to the biofeedback content provision service to and from other terminals and/or external servers (e.g., the electronic device 300 and/or server 100 in the embodiment).

This communicator 270 may wirelessly transmit and receive data with at least one of a base station, an external terminal, or any server on a mobile communication network established through a communication device (e.g., a communication chip that performs Bluetooth communication) capable of implementing technical standards or communication methods (e.g., Long Term Evolution (LTE), Long Term Evolution-Advanced (LTE-A), 5G New Radio (NR), Wi-Fi)) or short-range communication methods for mobile communication.

In the embodiment, the communicator 270 may transmit and receive predetermined data with the electronic device 300 through short-range communication using Bluetooth.

The current removal circuit 280 may be configured to generate a current for removing a portion of the DC component of the photocurrent from the optical sensor 211. The operation of the current removal circuit 280 may be controlled by the controller 290.

For example, referring to FIG. 5, the DAC 81 may be connected to the light receiver 22 of the optical sensor 211. The DAC 81 may be configured to generate a predetermined DC current according to a digital code.

The current removal circuit 280 may include the DAC 81 that is connected to the light receiver 22 and generates a current for removing a portion of the DC component of the photocurrent from the light receiver 22.

The photocurrent generated by the light receiver 22 and the current from the DAC 81 may be in opposite directions, and accordingly, a portion of the photocurrent generated by the light receiver 22 may be canceled out by the current from the DAC 81 and eliminated.

The current obtained by removing the DC component equivalent to the current generated by the first DAC 81 from the photocurrent generated by the light receiver 22 may be amplified and output through an amplifier 23. The current amplified and output by the amplifier 23 may be input to an analog-to-digital converter (ADC) 24 and converted into digital data. The digital data generated by the ADC 24 may be used as basic data for extracting bio data by the bio data extractor 17.

Referring to FIG. 6, the DAC 81 may include a bias voltage generator 31, a reference voltage generator 32, and a voltage-to-current converter 33.

The bias voltage generator 31 may generate a bias voltage V_{B} that serves as a basis for generating a current for removing a portion of the DC component of the photocurrent from the light receiver 22.

For example, referring to FIG. 7, the bias voltage generator 31 may include a voltage divider that divides an input power supply voltage VDD from the outside into a plurality of resistors. In this case, the bias voltage generator 31 may output a bias voltage V_{B} generated based on the power supply voltage VDD, and the bias voltage V_{B} may be input to the reference voltage generator 32.

The reference voltage generator 32 may amplify the bias voltage V_{B} from the bias voltage generator 31 to generate a reference voltage V_{REF}. The reference voltage V_{REF} generated by the reference voltage generator 32 may be input to the voltage-to-current converter 33.

For example, referring to FIG. 8, the reference voltage generator 32 may include the amplifier 42 that amplifies the bias voltage V_{B} and a first switching circuit structure 41 that connects the bias voltage generator 31 and the amplifier 42 and is configured to change an input terminal of the amplifier 42 to which the bias voltage is input.

The amplifier 42 may include, for example, a structure of an operational amplifier that includes an inverting input terminal and a non-inverting input terminal and includes an inverting output terminal and a non-inverting output terminal.

The amplifier 42 may amplify the bias voltage V_{B} received through an inverting input terminal or a non-inverting input terminal to generate the reference voltage V_{REF}. In this case, the input terminal of the amplifier 42 to which the bias voltage V_{B} is input may be changed by the first switching circuit structure 41.

In addition, the reference voltage V_{REF} which is generated by amplifying the bias voltage V_{B} by the amplifier 42 may be output through the inverting output terminal or non-inverting output terminal of the amplifier 42. In this case, the output terminal of the amplifier 42 from which the reference voltage V_{REF} is output may be changed by the second switching circuit structure 43.

Hereinafter, a method of controlling the first switching circuit structure 41 and the second switching circuit structure 43 will be described, with reference to FIGS. 8 to 10.

Referring to FIG. 8, the first switching circuit structure 41 may be provided at an input terminal side of the amplifier 42. The first switching circuit structure 41 may be referred to as a chopping circuit. The first switching circuit structure 41 may be configured to periodically change the input terminal of the amplifier 42, to which a bias voltage V_{B} is input, according to a predetermined chopping frequency PCHOP.

For example, referring to FIG. 9, the first switching circuit structure 41 may be controlled so that, at a first point in time, the bias voltage V_{B} is input to the non-inverting input terminal of the amplifier 42 and the output terminal of the bias voltage generator 31 is connected to the non-inverting input terminal of the amplifier 42. At the same time, the first switching circuit structure 41 may be controlled so that the inverting input terminal of the amplifier 42 is connected to the output terminal of the amplifier 42 at the first point in time.

The reference voltage V_{REF} generated by amplifying the bias voltage V_{B} input to the non-inverting input terminal of the amplifier 42 at the first point in time may be a voltage that reflects the non-inverting offset of the amplifier 42. Here, the non-inverting offset of the amplifier 42 may be referred to as a first offset, and the reference voltage V_{REF} that reflects the first offset may be referred to as a first reference voltage.

In addition, referring to FIG. 10, the first switching circuit structure 41 may be controlled so that the bias voltage V_{B} is input to the inverting input terminal of the amplifier 42 and the output terminal of the bias voltage generator 31 is connected to the inverting input terminal of the amplifier 42 at a second point in time different from the first point in time. At the same time, the first switching circuit structure 41 may be controlled so that the non-inverting input terminal of the amplifier 42 is connected to the output terminal of the amplifier 42 at the second point in time.

The reference voltage V_{REF} generated by amplifying the bias voltage V_{B} input to the inverting input terminal of the amplifier 42 at the second point in time may be a voltage that reflects the inverting offset of the amplifier 42. Here, the inverting offset of the amplifier 42 may be referred to as a second offset, and the reference voltage V_{REF} that reflects the second offset may be referred to as a second reference voltage.

In this way, the first switching circuit structure 41 may be controlled so that the output terminal of the bias voltage generator 31 is alternately connected to the inverting input terminal and non-inverting input terminal of the amplifier 42. In addition, the first switching circuit structure 41 may be controlled so that the output terminal of the amplifier 42 is alternately connected to the inverting input terminal and non-inverting input terminal of the amplifier 42.

Meanwhile, referring to FIG. 8, the second switching circuit structure 43 may be configured to periodically change the output terminal of the amplifier 42 from which the reference voltage V_{B} is output. In this case, the second switching circuit structure 43 may be configured to periodically change the output terminal of the amplifier 42 from which the reference voltage V_{B} is output according to the same frequency as the chopping frequency P_{CHOP} of the first switching circuit structure 41.

For example, referring to FIG. 9, the second switching circuit structure 43 may be controlled so that the reference voltage V_{REF} is output from the non-inverting output terminal of the amplifier 42 at the first point in time. In this case, the non-inverting output terminal of the amplifier 42 may be connected to the inverting input terminal of the amplifier 42.

Accordingly, a first reference voltage V_{REF} that reflects the non-inverting offset of the amplifier 42 may be output through the non-inverting output terminal of the amplifier 42 at the first point in time.

In addition, referring to FIG. 10, for example, the second switching circuit structure 43 may be controlled so that the reference voltage V_{REF} is output from the inverting output terminal of the amplifier 42 at the second point in time. In this case, the inverting output terminal of the amplifier 42 may be connected to the non-inverting input terminal of the amplifier 42.

Accordingly, a second reference voltage V_{REF} that reflects the inverting offset of the amplifier 42 may be output through the inverting output terminal of the amplifier 42 at the second point in time.

The voltage-to-current converter 33 may convert the reference voltage V_{REF} from the reference voltage generator 32 into a current to generate a current I_{DAC} for removing a portion of the DC component of the photocurrent from the light receiver 22.

In this case, the voltage-to-current converter 33 may convert the reference voltage V_{REF} into a current based on a digital code determined by the digital code determinator 13 of the server 100 to generate the current I_{DAC} for removing a portion of the DC component of the photocurrent from the light receiver 22.

For example, referring to FIG. 7, the voltage-to-current converter 33 may include a structure in which a predetermined amplifier, a resistor, and a plurality of transistors connected in parallel. The same power supply voltage VDD may be supplied to the plurality of transistors.

The output terminal of the reference voltage generator 32 may be connected to an input terminal of the voltage-to-current converter 33.

At the first point in time, the first reference voltage V_{REF} may be output from the reference voltage generator 32, and the voltage-to-current converter 33 may convert the first reference voltage V_{REF} from the reference voltage generator 32 into the current I_{DAC}.

In addition, at the second point in time, the second reference voltage V_{REF} may be output from the reference voltage generator 32, and the voltage-to-current converter 33 may convert the second reference voltage V_{REF} from the reference voltage generator 32 into the current I_{DAC}.

Meanwhile, referring to FIG. 11, the bias voltage generator 34 according to another embodiment may be connected to the reference voltage generator 32.

For example, the bias voltage generator 34 according to another embodiment may include a structure of a bandgap reference circuit.

Here, the bandgap reference circuit is configured to generate a fixed output voltage and may provide a stable output voltage regardless of a temperature change. The configuration of the bandgap reference circuit is well known in the field of electronic circuits, and thus a description thereof is omitted.

The controller 290 may include at least one processor capable of executing instructions of an application stored in the electronic device 300 in order to perform various tasks for providing an environment for providing bio data and biofeedback content.

In addition, in the embodiment, the controller 290 may control the overall operation of the components of the wearable device 200 in order to provide the environment for providing bio data and biofeedback content.

In detail, in the embodiment, the controller 290 may include an embedded processor that connects the optical sensor 211 of the sensor unit 210 to an analog front-end and then controls the analog-to-digital converter (ADC) to acquire a PPG signal.

Furthermore, the controller 290 may control the operation of the DAC 81 included in the current removal circuit 280. For example, the controller 290 may control the operation of the bias voltage generator 31, the reference voltage generator 32, and the voltage-to-current converter 33 that are included in the DAC 81. In addition, the controller 290 may control the operation of the first switching circuit structure 41 and second switching circuit structure 43 that are included in the reference voltage generator 32.

This controller 290 may be a system-on-chip (SOC) suitable for the wearable device 200, and may execute an operating system (OS) and/or application programs stored in the memory 260, and control each component mounted on the wearable device 200. Furthermore, the controller 290 may communicate with each component internally via a system bus and may include one or more predetermined bus structures, including a local bus.

In addition, the controller 290 may be implemented by including at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

In addition, the controller 290 may control the wearable device 200 by exchanging data with the electronic device 300 in response to signals received from the sensor unit 210 and/or the input unit 220.

The wearable device 200 including the above-described components may transmit sensing data including at least one or more of bio data such as heart rate data and oxygen saturation data and at least one or more of location data, distance data, and/or posture data to the electronic device 300 according to the embodiment, and such various types of data may be stored in a memory 310 of the electronic device 300.

### Electronic Device 300

An electronic device 300 according to an embodiment may be a computing device having an application 311 installed thereon that provides bio data and biofeedback content.

In detail, from a hardware point of view, the electronic device 300 may include a mobile type computing device and/or a desktop type computing device on which the application 311 is installed.

In the embodiment, the user is a user who exercises while carrying a wearable device 200 and the electronic device 300. For convenience of description, the electronic device 300 will be described below on the basis of being a mobile type computing device.

Here, the mobile computing device may be a mobile device, such as a smartphone or tablet PC, on which the application is installed.

For example, the mobile computing device may include a smartphone, a mobile phone, a digital broadcasting device, a personal digital assistant (PDA), a portable multimedia player (PMP), a tablet PC, etc.

In addition, depending on the embodiment, the electronic device 300 may further include a server computing device that provides the biofeedback content provision environment.

Referring to FIG. 12, from a functional point of view, the electronic device 300 may include a memory 310, a processor assembly 320, a communication module 330, an interface module 340, an input system 350, a sensor system 360, and a display system 370. These components may be configured to be included within the housing of the electronic device 300.

In detail, an application 311 is stored in the memory 310, and the application 311 may store one or more of various application programs, data, and instructions for providing a bio data acquisition service and/or a biofeedback content provision service.

In addition, the memory 310 may include a program area and a data area.

Here, the program area according to the embodiment may be linked between the operating system (OS) that boots the electronic device 300 and functional elements, and the data area may store data generated according to the use of the electronic device 300.

In addition, the memory 310 may include at least one or more non-transitory computer-readable storage media and a temporary computer-readable storage medium.

For example, the memory 310 may be a variety of storage devices, such as a ROM, EPROM, flash drive, or hard drive, and may include web storage that performs a storage function of the memory 310 on the Internet.

The processor assembly 320 may include at least one or more processors capable of executing instructions of the application 311 stored in the memory 310 in order to perform various tasks for generating the biofeedback content provision environment.

In the embodiment, the processor assembly 320 may control the overall operation of components through the application 311 of the memory 310 in order to provide the biofeedback content provision environment.

The processor assembly 320 may execute the application 311 to provide the user with biofeedback content that guides a customized exercise program based on various types of bio data, such as the user's heart rate and body temperature, measured by the sensor unit 210 included in the wearable device 200.

Here, the biofeedback content according to an embodiment may mean predetermined content generated by an electronic device 300 in order to guide customized exercise according to the user's condition based on user data such as body temperature data, PPG data, and motion data based on data sensed in real time through the sensor unit 210 of the wearable device 200.

In an embodiment, such biofeedback content may include audio coaching content (hereinafter, audio coaching) output to the wearable device 200 and visual coaching content output to the electronic device 300.

For example, in an embodiment, the biofeedback content data generated by the processor assembly 320 may be transmitted to the wearable device 200 via the communication module 330, and the controller 290 of the wearable device 200 may control the audio coaching content to be output via the output unit 230 based on data of the received biofeedback content.

Accordingly, by outputting audio coaching content as sound by the wearable device 200 according to an embodiment, the wearable device 200 may provide the biofeedback content to the user based on the user's sensing data acquired in real time.

The visual coaching content output to the electronic device 300 may be content displayed through a display system 370 of the electronic device 300.

The processor assembly 320 may be a system on chip (SOC) suitable for the electronic device 300 including a central processing unit (CPU) and/or a graphics processing unit (GPU), and may execute an operating system (OS) and/or application programs stored in the memory 310 and control each component mounted on the electronic device 300.

In addition, the processor assembly 320 may communicate with each component internally via a system bus and may include one or more predetermined bus structures, including a local bus.

In addition, the processor assembly 320 may be implemented by including at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

The communication module 330 may include one or more devices for communicating with external devices. This communication module 330 may communicate via a wireless network.

In detail, the communication module 330 may communicate with the server 100 that stores content sources for implementing the biofeedback content provision environment, and may communicate with various user input components, such as a controller that receives user input.

In the embodiment, the communication module 330 may transmit and receive various data related to the biofeedback content provision environment to and from other electronic devices and/or external servers.

This communication module 330 may wirelessly transmit and receive data with at least one of a base station, an external terminal, or any server on a mobile communication network established through a communication device capable of implementing technical standards or communication methods (e.g., Long Term Evolution (LTE), Long Term Evolution-Advanced (LTE-A), 5G New Radio (NR), Wi-Fi)) or short-range communication methods for mobile communication.

The interface module 340 may communicatively connect the electronic device 300 to one or more other devices. In detail, the interface module 340 may include wired and/or wireless communication devices compatible with one or more different communication protocols.

Through this interface module 340, the electronic device 300 may be connected to various input/output devices.

For example, the interface module 340 may be connected to an audio output device, such as a headset port or speaker, to output audio.

Although it has been exemplarily described that the audio output device is connected through the interface module 340, an embodiment in which the audio output device installed inside the electronic device 300 may also be included.

In addition, for example, the interface module 340 may be connected to an input device, such as a keyboard and/or mouse, to acquire user input.

This interface module 340 may be configured to include at least one of a wired/wireless headset port, an external charger port, a wired/wireless data port, a memory card port, a port for connecting a device equipped with an identification module, an audio input/output (I/O) port, a video input/output (I/O) port, an earphone port, a power amplifier, an RF circuit, a transceiver, and other communication circuits.

The input system 350 may detect user input (e.g., gestures, voice commands, button operations, or other types of input).

In detail, the input system 350 may include a predetermined button, a touch sensor, and/or an image sensor that receives user motion input.

In addition, the input system 350 may be connected to an external controller via the interface module 340 to receive user input.

The sensor system 360 may include an image sensor 361, a position sensor (IMU) 363, and an audio sensor 365. In addition, the sensor system 360 may further include various sensors, such as a distance sensor, a proximity sensor, and a contact sensor.

Here, the image sensor 361 may capture images and/or video of a physical space surrounding the electronic device 300.

The image sensor 361 may capture video by photographing the direction in which it is disposed, such as on the front or/and back of the electronic device 300, and may photograph the physical space through a camera disposed toward the outside of the electronic device 300.

The image sensor 361 may include an image sensor device and a video processing module. In detail, the image sensor 361 may process still images or moving images acquired by the image sensor device (e.g., CMOS or CCD).

The position sensor (IMU) 363 may detect at least one or more of the movement and acceleration of the electronic device 300. For example, the position sensor may be made up of a combination of various position sensors, such as an accelerometer, a gyroscope, and a magnetometer. Such a position sensor (IMU) may also be referred to as a motion sensor hereinafter.

In addition, the position sensor (IMU) 363 may recognize spatial information about the physical space surrounding the electronic device 300 by linking with the GPS of the communication module 330.

The audio sensor 365 may recognize sounds surrounding the electronic device 300.

In detail, the audio sensor 365 may include a microphone capable of detecting voice input from a user using the electronic device 300.

The display system 370 may output various information related to the biofeedback content provision environment as graphic images.

In the embodiment, the display system 370 may display various user interfaces (e.g., a membership registration interface in the embodiment) for the biofeedback content provision environment.

Such a display may include at least one of a liquid crystal display (LCD), a thin film transistor-liquid crystal display (TFT LCD), an organic light emitting diode (OLED), a flexible display, a 3D display, and an e-ink display.

The components described above may be disposed within the housing of the electronic device 300, and the user interface may include a touch sensor 373 on a display 371 configured to receive a user's touch input.

In detail, the display system 370 may include the display 371 that outputs images and the touch sensor 373 that detects a user's touch input.

For example, the display 371 may be implemented as a touch screen by forming a mutual layered structure or being integrally formed with the touch sensor 373. This touch screen may function as a user input unit that provides an input interface between the electronic device 300 and the user, and may also provide an output interface between the electronic device 300 and the user.

The electronic device 300 including the above-described components may store, depending on the embodiment, at least one piece of sensing data, user body information, user condition information, user exercise information, user exercise ability, and/or exercise program in the memory 310.

### Method for Generating Bio Data (S100)

The user's bio data may be acquired through the wearable device 200 including the optical sensor 211 according to the method for generating bio data (S100).

Referring to FIG. 13, a method for acquiring bio data (S100) according to an embodiment may include controlling an operation of the optical sensor 211 to irradiate a user's body with light and generating a photocurrent by receiving reflected light reflected from the user's body (S101), generating a bias voltage V_{B} (S103), generating a first reference voltage reflecting a first offset of the reference voltage generator 32 based on the bias voltage V_{B} (S105), generating a first current by converting a first reference voltage (S107), generating a second reference voltage reflecting a second offset of the reference voltage generator 32 based on the bias voltage V_{B} (S109), generating a second current by converting the second reference voltage (S111), and generating bio data based on data regarding the photocurrent, data regarding the first current, and data regarding the second current (S113).

The method for generating bio data (S100) may be performed by at least one or more processors included in the server 100. However, it is not limited thereto, and at least a portion of the method (S100) may be performed by the controller 290 of the wearable device 200 or the processor assembly 320 of the electronic device 300, and the other portions may be performed by at least one or more processors of the server 100. In addition, the method (S100) may be performed by the controller 290 of the wearable device 200 or the processor assembly 320 of the electronic device 300.

For example, at least one of at one or more processors included in the server 100, the controller 290 of the wearable device 200, and the processor assembly 320 included in the electronic device 300 may execute at least one instruction stored in the memory included in the server 100, the memory 260 of the wearable device 200, or the memory 310 of the electronic device 300 to perform the method (S100) for acquiring bio data using an optical device.

Hereinafter, it will be described that at least one or more processors of the server 100 performs the method (S100).

In step S101, at least one or more processors of the server 100 may control the operation of the optical sensor 211 of the wearable device 200 to irradiate the user's body with light and receive reflected light reflected from the user's body.

For example, at least one or more processors of the server 100 may control the light emitter 21 of the optical sensor 211 to irradiate the user's body with light. The light receiver 22 of the optical sensor 211 may receive reflected light reflected from the user's body to generate a photocurrent.

At least one or more processors of the server 100 may generate data regarding the photocurrent from the optical sensor 211.

In step S103, at least one or more processors of the server 100 may control the operation of the bias voltage generator 31 of the DAC 81 included in the current removal circuit 280 connected to the optical sensor 211 a control signal based on to generate a bias voltage V_{B}.

In step S105, the bias voltage V_{B} from the bias voltage generator 31 may be amplified by the reference voltage generator 32 to generate a first reference voltage reflecting a first offset of the reference voltage generator 32.

For example, at the first point in time, a bias voltage V_{B} may be input to a non-inverting input terminal of the amplifier 42 of the reference voltage generator 32 by the first switching circuit structure 41 of the reference voltage generator 32, and an inverting input terminal of the amplifier 42 may be connected to an output terminal of the amplifier 42. In addition, at the same time, the second switching circuit structure 42 of the reference voltage generator 32 at the first point in time may be controlled so that a voltage output from the amplifier 42 is output from a non-inverting output terminal of the amplifier 42.

In this case, the first reference voltage generated from the reference voltage generator 32 at the first point in time may be a voltage reflecting the first offset of the amplifier 42, i.e., a non-inverting offset.

In addition, the first reference voltage, which reflects the first offset of the reference voltage generator 32, may be converted by the voltage-to-current converter 33 to generate a first current.

In this case, the first reference voltage may be converted by the voltage-to-current converter 33 based on a digital code determined by at least one or more processors of the server 100 to generate the first current.

Here, the first current may be a current in which the influence of the first offset is reflected in a current corresponding to a digital code determined by at least one or more processors of the server 100.

At least one or more processors of the server 100 may generate data regarding the first current generated by converting the first reference voltage by the voltage-to-current converter 33.

In step S107, the bias voltage V_{B} from the bias voltage generator 31 may be amplified by the reference voltage generator 32 to generate a second reference voltage reflecting a second offset of the reference voltage generator 32.

For example, at the second point in time, a bias voltage V_{B} is input to the inverting input terminal of the amplifier 42 of the reference voltage generator 32 by the first switching circuit structure 41 of the reference voltage generator 32, and the non-inverting input terminal of the amplifier 42 may be connected to the output terminal of the amplifier 42. In addition, at the same time, the second switching circuit structure 42 of the reference voltage generator 32 at the second point in time may be controlled so that a voltage output from the amplifier 42 is output from an inverting output terminal of the amplifier 42.

In this case, the second reference voltage generated from the reference voltage generator 32 at the second point in time may be a voltage reflecting the second offset of the amplifier 42, i.e., an inverting offset.

In addition, the second reference voltage, which reflects the second offset of the reference voltage generator 32, may be converted by the voltage-to-current converter 33 to generate a second current.

In this case, the second reference voltage may be converted by the voltage-to-current converter 33 based on a digital code determined by at least one or more processors of the server 100 to generate the second current.

Here, the second current may be a current in which the influence of the second offset is reflected in a current corresponding to a digital code determined by at least one or more processors of the server 100.

At least one or more processors of the server 100 may generate data regarding the second current generated by converting the second reference voltage by the voltage-to-current converter 33.

In step S109, at least one or more processors of the server 100 may generate bio data based on data regarding the photocurrent, data regarding the first current, and data regarding the second current.

At least one or more processors of the server 100 may perform a predetermined operation to minimize the influence of the first offset reflected in the first current and the influence of the second offset reflected in the second current during the process of generating the bio data.

For example, referring to FIG. 14, generating the bio data (S109-1) according to an embodiment may include generating data regarding an average current obtained by averaging the first current and second current (S1091) and generating bio data based on data regarding a current obtained by removing a portion of the DC component equivalent to the average current from the photocurrent (S1093).

In step S1091, at least one or more processors of the server 100 may calculate an average current obtained by averaging the first current and second current based on the data regarding the first current and the data regarding the second current.

During this process, the influence of the first offset reflected in the first current and the influence of the second offset reflected in the second current may be cancelled each other out.

In step S1093, at least one or more processors of the server 100 may generate bio data based on data regarding the current obtained by removing a portion of the DC component equivalent to the average current from the photocurrent.

Here, the average current is a current in which the influence of the offset of the amplifier 42 included in the reference voltage generator 32 is minimized, and may be a current corresponding to a digital code determined by at least one or more processors of the server 100.

Accordingly, bio data may be generated based on the current obtained by removing the current corresponding to the digital code determined by at least one or more processors of the server from the photocurrent.

In addition, for example, referring to FIG. 15, generating bio data (S109-2) according to another embodiment includes generating data regarding a first reference current obtained by removing a portion of the DC component equivalent to the first current from the photocurrent (S1101), generating data regarding a second reference current obtained by removing a portion of the DC component equivalent to the second current from the photocurrent (S1103), generating data regarding the average reference current obtained by averaging the first reference current and second reference current (S1105), and generating bio data based on the data regarding the average reference current (S1107).

In step S1101, at least one or more processors of the server 100 may generate data regarding the first reference current obtained by removing a portion of the DC component equivalent to the first current from the photocurrent.

Here, the first reference current may be a current obtained by removing a portion of the DC component equivalent to the first current in which the influence of the first offset of the amplifier 42 included in the reference voltage generator 32 is reflected from the photocurrent.

In step S1103, at least one or more processors of the server 100 may generate data regarding the second reference current obtained by removing a portion of the DC component equivalent to the second current from the photocurrent.

Here, the second reference current may be a current obtained by removing a portion of the DC component equivalent to the second current in which the influence of the second offset of the amplifier 42 included in the reference voltage generator 32 is reflected from the photocurrent.

In step S1105, at least one or more processors of the server 100 may calculate an average reference current obtained by averaging the first reference current and the second reference current based on the data regarding the first reference current and the data regarding the second reference current.

During this process, the influence of the first offset reflected in the first reference current and the influence of the second offset reflected in the second reference current may be cancel each other out.

In step S1107, at least one or more processors of the server 100 may generate bio data based on data regarding the average reference current.

Here, the average reference current is the current in which the influence of the first offset reflected in the first reference current and the influence the second offset reflected in the second reference current are cancel each other out.

Therefore, the bio data generated based on the average reference current may correspond to bio data generated based on a current obtained by removing the current corresponding to the digital code determined by at least one or more processors of the server 100 from the photocurrent.

Furthermore, referring to FIG. 16, for example, generating bio data (S109-3) of according to still another embodiment may include generating first bio data based on data regarding the first reference current obtained by removing a portion of the DC component equivalent to the first current from the photocurrent (S1111), generating second bio data based on data regarding the second reference current obtained by removing a portion of the DC component equivalent to the second current from the photocurrent (S1113), and generating final bio data obtained by averaging the first bio data and the second bio data.

In step S1111, at least one or more processors of the server 100 may generate data regarding the first reference current obtained by removing a portion of the DC component equivalent to the first current from the photocurrent, and generate first bio data based on the data regarding the first reference current.

Here, the first reference current is a current obtained by removing a portion of the DC component equivalent to the first current in which the influence of the first offset of the amplifier 42 included in the reference voltage generator 32 is reflected from the photocurrent, and thus the first bio data generated based on the data regarding the first reference current is data that reflects the influence of the first offset.

In step S1113, at least one or more processors of the server 100 may generate data regarding the second reference current obtained by removing a portion of the DC component equivalent to the second current from the photocurrent, and generate second bio data based on the data regarding the second reference current.

Here, the second reference current is a current obtained by removing a portion of the DC component equivalent to the second current in which the influence of the second offset of the amplifier 42 included in the reference voltage generator 32 is reflected from the photocurrent, and thus the second bio data generated based on the data regarding the second reference current is data that reflects the influence of the second offset.

In step S1115, at least one or more processors of the server 100 may calculate an average of the first bio data and the second bio data to generate final bio data.

During this process, the influence of the first offset reflected in the first bio data and the influence of the second offset reflected in the second bio data may be cancel each other out.

Embodiments according to various embodiments of the present disclosure may provide a wearable device including an optical sensor, that can minimize errors in bio data due to an offset in the current removal circuit for removing unnecessary noise currents for extracting bio data from the photocurrent generated by the optical sensor by minimizing the offset that may occur in the amplifier included in the current removal circuit using a chopping circuit, a system for generating bio data including the same, and a method for generating bio data using the optical sensor.

However, the effects that can be obtained through various embodiments of the present disclosure are not limited to the effects mentioned above, and other effects that are not mentioned can be clearly understood from the description below.

The embodiments of the present disclosure described above may be implemented in the form of program instructions that can be executed by various computer components and recorded on a computer-readable recording medium. The computer-readable recording medium may contain program instructions, data files, data structures, and the like, either singly or in combination. The program instructions recorded on the computer-readable recording medium may be specially designed and configured for the present disclosure or may be known and available to those skilled in the art of computer software. Examples of computer-readable recording media include magnetic media such as hard disks, floppy disks, and magnetic tape, optical recording media such as CD-ROMs and DVDs, magneto-optical media such as floptical disks, and hardware devices specifically configured to store and execute program instructions, such as ROM, RAM, and flash memory. Examples of the program instructions include not only machine language code, such as that generated by a compiler, but also high-level language code that can be executed by a computer using an interpreter or the like. Hardware devices may be modified into one or more software modules to perform processing according to the present disclosure, and vice versa.

The specific implementations described herein are exemplary and do not limit the scope of the present disclosure in any way. For the sake of brevity of the specification, descriptions of conventional electronic components, control systems, software, and other functional aspects of the systems may be omitted. In addition, the lines or connecting members connecting between components depicted in the drawings are merely representative of functional connections and/or physical or circuit connections, and may be represented as a variety of functional connections, physical connections, or circuit connections that are replaceable or additional in actual devices. In addition, if there is no specific mention such as “essential” or “importantly,” it may not be a component absolutely necessary for the application of the present invention.

In addition, although the detailed description of the present invention has been described with reference to preferred embodiments of the present invention, anyone skilled in the art or having ordinary knowledge in the art will understand that the present invention can be modified and changed in various ways within the scope that does not depart from the spirit and technical scope of the present invention as described in the claims below. Therefore, the technical scope of the present invention should not be limited to the contents described in the detailed description of the specification, but should be determined by the patent claims.

1. A wearable device comprising:
an optical sensor, comprising:
a light emitter configured to irradiate a user's body with light; and
a light receiver configured to generate a photocurrent by receiving reflected light from the user's body;
a current removal circuit configured to generate a current for removing a portion of a direct current (DC) component of the photocurrent; and
a controller configured to control an operation of the current removal circuit and generate bio data based on a current obtained by removing a portion of the DC component equivalent to the current generated by the current removal circuit from the photocurrent,
wherein the current removal circuit includes:
a bias voltage generator configured to generate a bias voltage that serves as a basis for generating the current for removing the portion of the DC component of the photocurrent;
a reference voltage generator configured to amplify the bias voltage to generate a first reference voltage reflecting a first offset at a first point in time, and to amplify the bias voltage to generate a second reference voltage reflecting a second offset at a second point in time different from the first point in time; and
a voltage-to-current converter configured to convert the first reference voltage and the second reference voltage to generate a current.

2. The wearable device of claim 1, wherein the first offset is a non-inverting offset of the reference voltage generator and the second offset is an inverting offset of the reference voltage generator.

3. The wearable device of claim 1, wherein the reference voltage generator includes:
an amplifier configured to amplify the bias voltage to generate a reference voltage; and
a first switching circuit structure configured to connect the bias voltage generator and the amplifier and periodically change an input terminal of the amplifier to which the bias voltage is input.

4. The wearable device of claim 3, wherein the controller is configured to:
control an operation of the first switching circuit structure so that the bias voltage is input to a non-inverting input terminal of the amplifier at the first point in time; and
control the operation of the first switching circuit structure so that the bias voltage is input to an inverting input terminal of the amplifier at the second point in time.

5. The wearable device of claim 3, wherein the current removal circuit includes a second switching circuit structure configured to periodically change an output terminal of the amplifier from which the reference voltage is output.

6. The wearable device of claim 5, wherein the controller is configured to:
control an operation of the second switching circuit structure so that the first reference voltage is output from a non-inverting output terminal of the amplifier at the first point in time; and
control the operation of the second switching circuit structure so that the second reference voltage is output from an inverting output terminal of the amplifier at the second point in time.

7. The wearable device of claim 1, wherein the controller is configured to:
generate data regarding a first current generated by converting the first reference voltage by the voltage-to-current converter;
generate data regarding a second current generated by converting the second reference voltage by the voltage-to-current converter;
generate data regarding an average current obtained by averaging the first current and the second current based on the data regarding the first current and the data regarding the second current; and
generate the bio data based on data regarding a current obtained by removing a portion of the DC component equivalent to the average current from the photocurrent.

8. The wearable device of claim 1, wherein the controller is configured to:
generate data regarding a first reference current obtained by removing a portion of the DC component equivalent to a first current generated by converting the first reference voltage by the voltage-current converter from the photocurrent;
generate data regarding a second reference current obtained by removing a portion of the DC component equivalent to a second current generated by converting the second reference voltage by the voltage-current converter from the photocurrent;
generate data regarding an average reference current obtained by averaging the first reference current and the second reference current based on the data regarding the first current and the data regarding the second reference current; and
generate the bio data based on the data regarding the average reference current.

9. The wearable device of claim 1, wherein the controller is configured to:
generate first bio data based on data regarding a first reference current obtained by removing a portion of the DC component equivalent to a first current generated by converting the first reference voltage by the voltage-current converter from the photocurrent;
generate second bio data based on data regarding a second reference current obtained by removing a portion of the DC component equivalent to a second current generated by converting the second reference voltage by the voltage-current converter from the photocurrent; and
generate final bio data obtained by averaging the first bio data and the second bio data.

10. A system for generating bio data, comprising:
an electronic device that includes a memory and a processor assembly; and
the wearable device of claim 1,
wherein, in the memory, an application providing a bio data acquisition service by being executed by the processor is stored.

11. A method for generating bio data using an optical sensor, comprising:
controlling an operation of the optical sensor to irradiate a user's body with light and generating data regarding a photocurrent by receiving reflected light reflected from the user's body;
generating a bias voltage;
acquiring data regarding a first current generated by converting a first reference voltage which is generated by amplifying the bias voltage along a first route of a reference voltage generator to reflect a first offset;
acquiring data regarding a second current generated by converting a second reference voltage which is generated by amplifying the bias voltage along a second route different from the first route of the reference voltage generator to reflect a second offset different from the first offset; and
generating bio data based on the data regarding the photocurrent, the data regarding the first current, and the data regarding the second current.

12. The method of claim 11, wherein the generating of the bio data includes:
generating data regarding an average current obtained by averaging the first current and the second current based on the data regarding the first current and the data regarding the second current; and
generating the bio data based on data regarding a current obtained by removing a portion of the DC component equivalent to the average current from the photocurrent.

13. The method of claim 11, wherein the generating of the bio data includes:
generating data regarding a first reference current obtained by removing a portion of the DC component equivalent to the first current from the photocurrent;
generating data regarding a second reference current obtained by removing a portion of the DC component equivalent to the second current from the photocurrent;
generating data regarding an average reference current obtained by averaging the first reference current and the second reference current based on the data regarding the first current and the data regarding the second reference current; and
generating the bio data based on the data regarding the average reference current.

14. The method of claim 11, wherein the generating of the bio data includes:
generating first bio data based on data regarding a first reference current obtained by removing a portion of the DC component equivalent to the first current from the photocurrent;
generating second bio data based on data regarding a second reference current obtained by removing a portion of the DC component equivalent to the second current from the photocurrent; and
generating final bio data obtained by averaging the first bio data and the second bio data.
